(19) United States
(12) Patent Application Publication
(10) Pub. No.: US 2013/0007578 A1
(43) Pub. Date: Jan. 3, 2013

(54) METHOD AND APPARATUS FOR DISPLAYING COMPONENT DOCUMENTS OF A COMPOSITE DOCUMENT

(75) Inventors: George V. Shreck, Springfield, VA (US); Andre Luiz Gomes, Bethesda, MD (US); Radoslav Tsanev, Arlington, VA (US); David Michael Hunt, McLean, VA (US)

(73) Assignee: Landon IP, Inc., Alexandria, VA (US)

(21) Appl. No.: 13/173,837

(22) Filed: Jun. 30, 2011

(51) Int. Cl. G06F 17/00

(52) U.S. Cl. 715/205

(57) ABSTRACT

A tool for navigating composite documents composed of multiple component documents. The tool allows a user to enter a composite document identification number, and thereafter have access to each component document within the composite document. The user can view, compare and display comparisons of the component documents, including versions of component documents. A graphical user interface is provided that prompts the user for required information and provides the user with many useful views for analyzing the component documents. In an embodiment, the composite document is the file history for a patent and the component documents are amendments, including application claims, and other papers found in a file history, such as the patent application, as originally filed, and the resulting patent. One feature of the tool allows the user to select a claim and have all versions of the claim displayed for easy review and analysis. This displaying ability allows the user to follow the progression of the claims during prosecution. The tool emphasizes all changes made to the claims, and provides annotations and links directly to the corresponding amending document.

### FIELD OF THE INVENTION

The present invention relates generally to the processing of electronic documents, and more specifically, to a system and method for analyzing composite documents, such as records of legal transactions and patent prosecution file histories.

### BACKGROUND

Most legal transactions have a long and complicated history of documents, whether in digital form or hard copy. Each phase of the transaction is documented, and as negotiations between parties to the transaction progress, the legal terms change and are documented in the document history.

As an example, a patent application is a transaction between the governing authority, such as the United States Patent and Trademark Office (USPTO), and the applicant for the patent. The applicant initiates the transaction, known as patent “prosecution”, by filing an application, which includes a “specification” describing the invention generally and “claims” which define the legal scope of the desired patent protection.

The applicant, often through an attorney and a Patent Examiner as a representative of the relevant patent office, engage in a series document exchanges that will eventually form the “prosecution history” or “file history” of the patent application and/or the resulting patent. Specifically, the Examiner will issue documents called “Office Actions” indicating perceived inadequacies in the patent application, such as rejections of the claims and objections to the specification. The applicant can respond to each Office Action with documents containing arguments and/or amendments to the claims or specification. Accordingly, the legal scope of patent protection often changes significantly during prosecution. Also, the applicant often makes representations upon which the Examiner relies in granting or rejecting the patent application. A document making changes to one or more patent application claims is referred to as a “claims amendment” herein.

In order to accurately understand the legal scope, i.e. the legal metes and bounds of the invention protected by a patent, it is critical to review and understand the prosecution history of the patent. Typically, when a patent becomes part of a legal action, such as an action for infringement of the patent, attorneys will spend many hours reviewing, parsing, and analyzing the file history in order to understand the patent. Patent file histories are often many hundreds of pages. Further, the legal scope is changed throughout the prosecution process and through the effect of many documents in the file history. Accordingly, the process of reviewing the patent file history is tedious and requires a great deal of resources. Most significantly, it is difficult to parse and understand the amendments made to the claims during prosecution and the corresponding representations made by the applicant.

Similarly, other legal transactions, such as merger or acquisition transactions have long histories of documents that must be reviewed, parsed and analyzed in order to understand the legal scope of the transaction. It is known to put document histories in electronic form and to search the text electronically in order to find desired words or phrases. While this is an advance over a totally manual method of reading and parsing the documents in the history, the task of understanding the effect of changes made to the legal scope is still resource intensive because it is difficult to ascertain where in the history the changes were made and which representations are made in correspondence to the changes.

Graphical User Interfaces (GUIs) are well known in the field of computers and computer applications. A GUI is designed to allow the information within the computer application to be displayed, usually in multiple ways, to the user. A typical user interface includes scroll bars that allow the user to scroll through a page or document that cannot be shown on the computer screen all at once. Typical user interfaces also provide links, or hyperlinks, to other places or objects on the page or document being viewed, and to other documents and webpages. A link can be presented as an object, such as a button to be clicked on. Links can also be presented, within a GUI, as a highlighted and/or underlined word or phrase. In both cases, clicking on the link causes a piece of code to be executed that causes the desired information to be fetched and presented to the user. GUI's for word processing applications also provide helpful functions, such as spell checker and the Find function, which allows the user to find the location of any word in the document. User interfaces may also present multiple windows within a display screen, so the user can view multiple documents simultaneously.

Documents and objects that can be linked to an existing electronic document, include word processing documents, Adobe® PDF files, webpages, image files, movie files, audio files, and other addressable objects. Exemplary word processing documents include .txt and .doc documents offered by Microsoft®, Inc. Link-able webpages are typically written in Hypertext Markup Language (HTML) and addressable via their Universal Resource Locator (URL), or Universal Resource Indicator (URI). Exemplary image files include JPEG, TIFF, GIFF and bit-map images. Link-able movie and audio files include .mov, Quicktime®, and WAV.

### SUMMARY

Methods, devices and computer programs for comparing portions of a composite document representing legal rights are disclosed. The composite document may be composed of one or plural component documents arranged in an ontology. At least one of the component documents being an amending document that affects changes to a legal rights declaration of the composite document.

A method in one embodiment comprises receiving a designation of at least two versions of the legal rights declaration, determining a corresponding amending document for each of the at least two versions of the legal rights declaration, generating a link to each of the corresponding amending documents and displaying a representation of each of the at least two versions of the legal rights declaration along with the link to each of the corresponding amending documents.

The step of displaying may further comprise displaying each of the at least two versions of the legal rights declaration in a corresponding column or a row of a chart along with the link to each of the corresponding amending documents in the same corresponding column or row of the chart. The method may further comprise the step of comparing the at least two versions of the legal right declaration, generating an indication of changes between the at least two versions of the legal right declaration, wherein said representation of each of the at least two versions of the legal rights declaration includes the indication of changes between the at least two versions of the legal right declaration, and the corresponding amending document is the document that affects the changes indicated by the indication of changes.

In an embodiment, the composite document is a patent file history, the component documents are papers filed by a patent applicant or issued by a patent office, the at least one amending document is a claims amendment, and the legal rights declaration is a patent application claim or a patent claim. Additionally, the step of receiving may further comprise presenting the user with a claims tree and allowing the user to select the at least two versions of the legal rights declaration from the claims tree.

In further embodiments, the displaying step further comprises displaying an indication of claim dependency. The composite document is a single file, and in some embodiments, is a record of a legal transaction.

### BRIEF DESCRIPTION OF THE DRAWINGS

An embodiment will now be described in more detail with reference to the accompanying drawings, given only by way of example, in which:

FIG. 1 is a block diagram of an exemplary device on which the present embodiment may operate;

FIG. 2 is a schematic diagram showing the software modules of the embodiment;

FIG. 3 shows an exemplary network connection of the device;

FIG. 4 shows an exemplary ontology for storing the component documents of the embodiment;

FIG. 5 shows an exemplary claim matrix that forms a portion of the preferred GUI that is presented to a user upon opening a composite document;

FIG. 6 is another exemplary portion of the GUI that allows for selection of a legal rights declaration;

FIG. 7 shows another exemplary portion of the GUI that allows for selection of versions of a legal rights declaration;

FIG. 8 shows another exemplary graphical user interface for selecting and comparing two versions of a claim;

FIG. 9 is another view of the graphical user interface for selecting and comparing two versions of a claim;

FIG. 10 is another view of the graphical user interface for selecting and comparing two versions of a claim;

FIG. 11 shows an exemplary comparison view of the present analyzing tool;

FIG. 12 is a continuation view of the exemplary comparison view shown in FIG. 11;

FIG. 13 is an exemplary user interface for selecting one or more claims for creating an evolved claims report;

FIG. 14 shows the top portion of an exemplary evolved claim report;

FIG. 15 shows the bottom portion of the exemplary evolved claim report;

FIG. 16 is a flow chart showing exemplary steps of an embodiment;

FIG. 17 is another flow chart showing exemplary steps of another embodiment;

FIG. 18 is another flow chart showing exemplary steps of yet another embodiment.

### DETAILED DESCRIPTION OF THE INVENTION

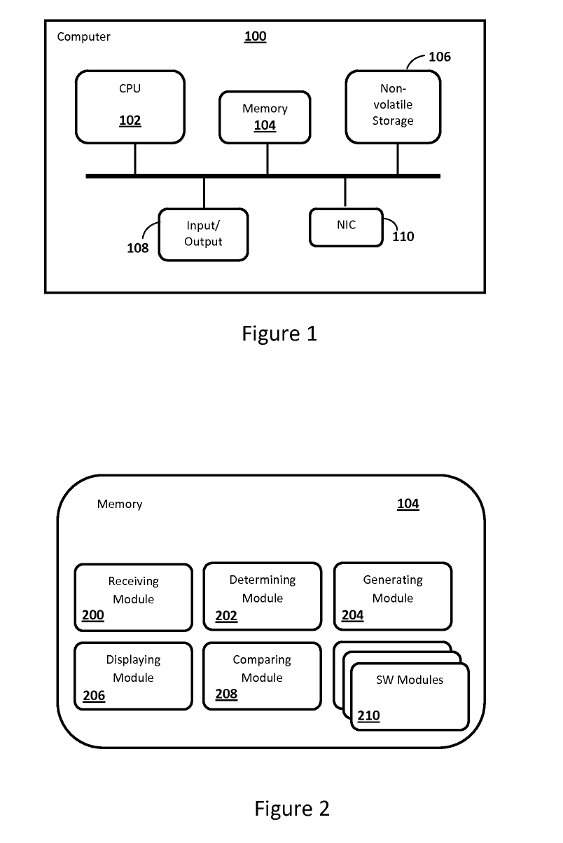

FIG. 1 shows an exemplary device, computer 100, on which the disclosed embodiment may operate. Computer 100 includes at least one Central Processing Unit (CPU) 102, a random access memory 104, a non-volatile storage device 106, a master input/output (I/O) unit 108, and a network interface card (NIC) 110. The computer can be any type of general purpose computing device, such as a PC, mobile device, or the like, or combination of one or more such devices. CPU 102 can be any well known, commercially available central processing unit, such as those offered by Intel®, Inc. The non-volatile storage device 106 allows for storage of all data and instructions required for causing computer 100 to carry out the preferred method. The master I/O unit 108 accepts input from the user, via a keyboard and a pointing device, such as a computer mouse. The I/O unit 108 also outputs display screen information for viewing by the user. The network interface card 110 provides the computer 110 with access to a network, such as a Local Area Network (LAN) or the Internet.

FIG. 2 illustrates memory 104 storing all modules in the preferred embodiment. The modules comprise computer readable code recorded on a tangible media. Receiving Module 200 receives input from the user, including a designation of a composite document, a legal rights declaration, and two or more versions of a legal rights declaration. Determining Module 202 finds one or more component documents, based on information received by the Receiving Module 200. Generating Module 204 generates a link to each of the one or more component documents found by the Determining Module 202. Displaying Module 206 includes a Graphical User Interface (GUI) that allows the information from the other modules to be displayed to the user in many helpful and time-saving ways. Comparing Module 208 provides for the comparison of multiple component documents, including multiple legal rights declarations. The other modules 210 provide other functionalities to the invention such as importing and exporting of the documents and reports. The disclosed modules are defined and segregated by function for convenience of description. However, the modules need not represent discrete files or sections of code recorded on media. The functions of the modules are described in greater detail below.

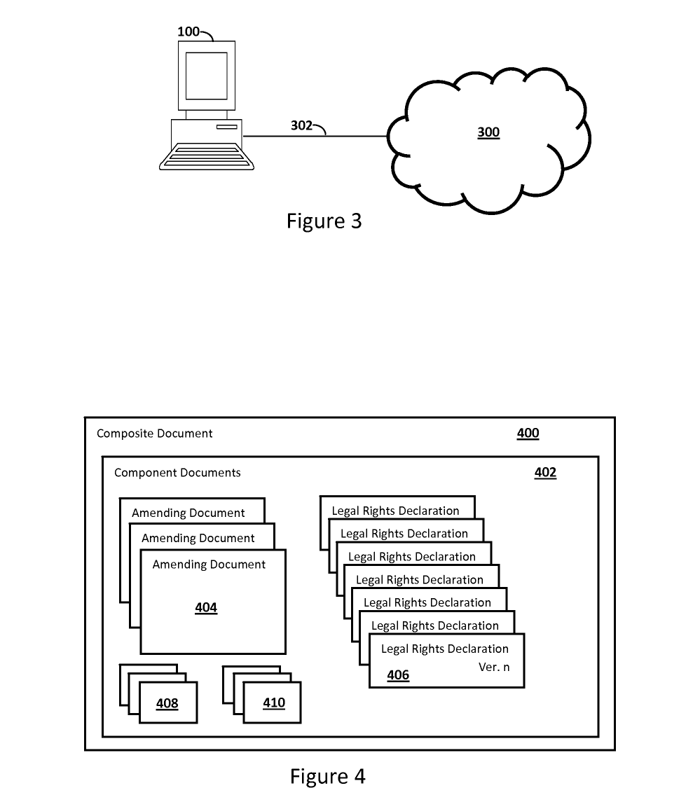

FIG. 3 shows the computer 100 connected to a network 300 via a wired connection 302. In other embodiments, a wireless connection to the network 300 can be used. The network 300 can be the Internet, or a LAN that the computer 100 uses to connect to the Internet. Once connected to the Internet, the computer 100 is able to import publicly available electronic data, including information available on federal government servers such as those that support the U.S. Patent and Trademark Office, the Federal Trade Commission, various Courts, and the Securities and Exchange Commission.

FIG. 4 illustrates the ontology of an exemplary composite document 400. A composite document can be any collection of related documents, images and objects that accumulate over some time period. In an embodiment, each of the accumulated documents are created by, or filed with, a government agency. The exemplary composite document 400 is the File History of a U.S. Patent Application. The composite document 400 is composed of many component documents 402. In the case of a File History, the component documents 402 include Amending Documents 404, Legal Rights Declarations 406, the original patent application 408, post issuance documents 410, and other documents such as Office Actions issued by the Patent Office. The patent application includes a description of the invention, and at least one claim, which defines the legal protection that a resulting patent will provide. Thus, each claim can be thought of as a Legal Rights Declaration. Each of the Amending Documents 404 can be used to amend, or change, the language in one or more of the Legal Rights Declarations 406. A single claim, or legal rights declaration, may be amended several times during prosecution with the U.S. Patent Office. A resulting claim, listed in a patent, may bare very little resemblance to the original claim that was filed with the patent application. The resulting patent and any Certificate of Correction(s) are included in the post issuance documents 410. Note that the ontology can have various levels. For example, a Legal Rights Declaration 406 can be part of an Amending Document 404.

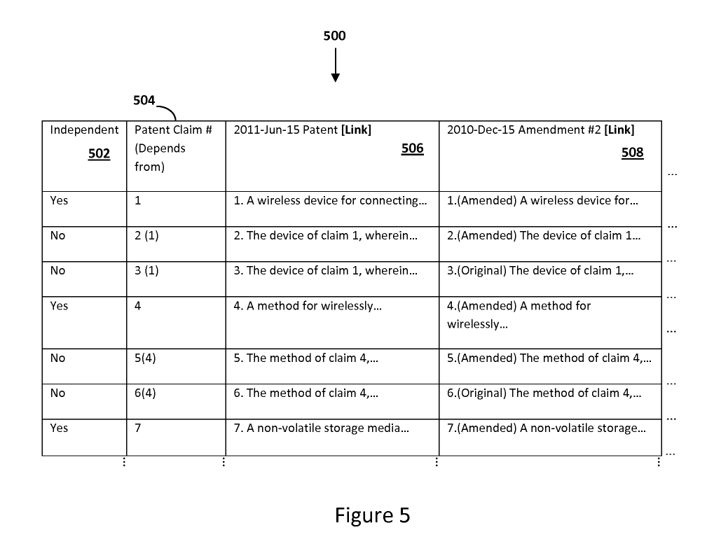

FIG. 5 shows an exemplary claims matrix 500 that can be presented to a user in response to user commands entered through receiving module 200. The claims matrix 500 can be displayed in a central window of the preferred graphical user interface. When the present analyzing tool is opened, the user is allowed to open a composite document, a computer file in the embodiment. The composite document, a file history in this example, can be imported from another program, downloaded from an e-mail, accessed from the computer's hard drive or from a remove-able disk or flash drive. The exemplary claims matrix 500 shows all claims in the patent application and resulting patent, associated with the file history. In the claims matrix 500, column 502 indicates whether the claim is Independent, or not. If the claim is Independent, then no other claims need be considered in determining the elements of the claim. The second column 504 shows the claim number and an indication of dependency. If the claim depends from another claim, then the claim it depends from, is shown in parenthesis. In the matrix 500, the patent claims are shown in the third column 506, and the application claims, as shown in Amendment #2, are shown in the fourth column 508. The embodiment also provides for showing the application claims, such as a child claim, after Amendment #1 in a fifth column (not shown), and the application claims as originally Filed in a sixth column (not shown). The preferred GUI allows for scrolling across the matrix, so that more than two versions can be viewed, and for scrolling downward, so that any number of claims, can be viewed. In an alternative view of the claims matrix, the claims as originally Filed can be displayed first, i.e., in the third column, and the resulting patent claims presented in the last column. Further, in the embodiment, a Link to each component document, or Amendment, associated with the different versions, is provided at the top of columns, 3-n, wherein n is the last column. Exemplary [Link]s are shown at the top of columns 506 and 508 in FIG. 5.

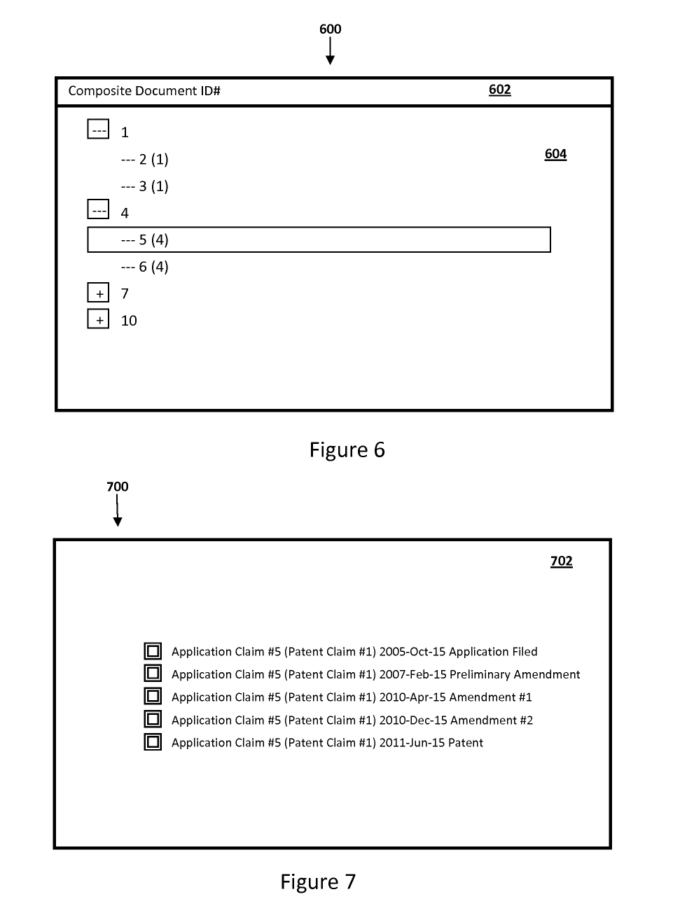

FIG. 6 shows an exemplary user interface 600 of the preferred GUI that allows for selection of a legal rights declaration, or claim, for comparison. The top window 602 of the interface 600 displays the identification number of the Composite Document. Window 604 of interface 600 displays the claims, by number, and an indication of each claim's dependency. In window 604, dependent claims are indicated as such by having the claim from which they depend listed next to them in parenthesis. In a patent application, independent claims stand alone, meaning no other claim(s) need be considered when determining the elements of the claim. Dependent claims, however, depend from at least one other claim, and the elements of the other claim(s) must be considered when determining the legal rights of the claim. Thus, the user can easily determine all claims that must be reviewed, when analyzing a specific claim. The user can select a claim by clicking on the claim number, which will highlight the claim. In FIG. 6, the user has selected claim #5 of the composite document to analyze. In the embodiment, each independent claim is provided with an expand/contract box that allows the claims that depend there from to be hidden or shown.

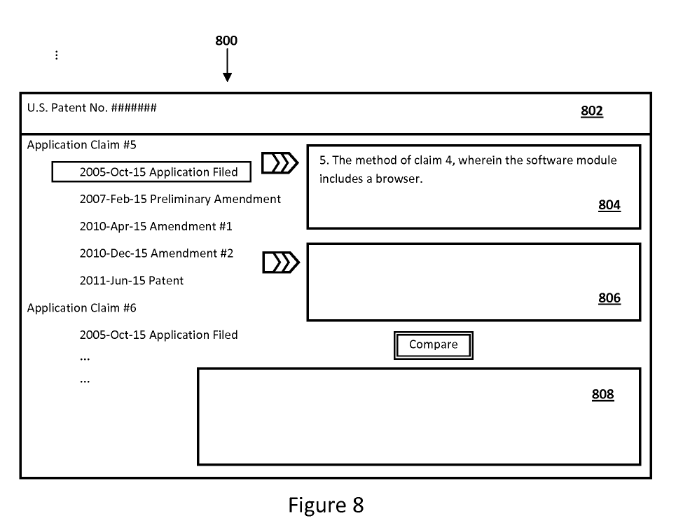

FIG. 7 shows an exemplary user interface 700 that allows for selection of different versions of a legal rights declaration, or claim. Patent applications are typically filed with claims that define the invention in very broad terms. This is done in an attempt to obtain very broad legal protection for the inventor or assignee. However, most patent application claims are amended at least once, before they become patent claims. Usually, the patent applicant is forced to narrow the scope of legal rights provided by the claim, via Amendment, or amending documents. It is very useful to those that work with patents to see the changes that a patent claim went through during prosecution through the U.S. Patent Office. In FIG. 6, claim 5 was selected by the user. In FIG. 7, representations of all versions of claim 5 are provided to the user in window 702. If the user wants to see claim 5 as it was originally filed, the user will click the check-box next to “Application Claim #5 (Patent Claim #1) 2005 Oct. 15 Application Filed.” By checking a second box, and thereby selecting a second version of claim 5, the user will be presented with both versions of application claim 5, along with an indication of changes between the two versions. Interface 700 allows the user to select any two versions of a claim, and invoke the comparison ability of the present analyzing tool. FIGS. 8-10 show exemplary graphical user interfaces for displaying the two versions and a comparison view of the versions along with an indication of the changes between the versions.

FIG. 8 illustrates an exemplary graphical user interface 800 for selecting and then comparing two versions of a claim, i.e., two versions of a legal rights declaration. The composite document ID number, a patent number in this example, is shown in the top window 802 of the interface 800. The user has selected the first version of claim #5, or claim #5 as filed, by clicking on “2005 Oct. 15 Application Filed” on the left side of the interface 800, which highlights the version. After clicking on the arrows box, the text of the original version of the claim is displayed in window 804.

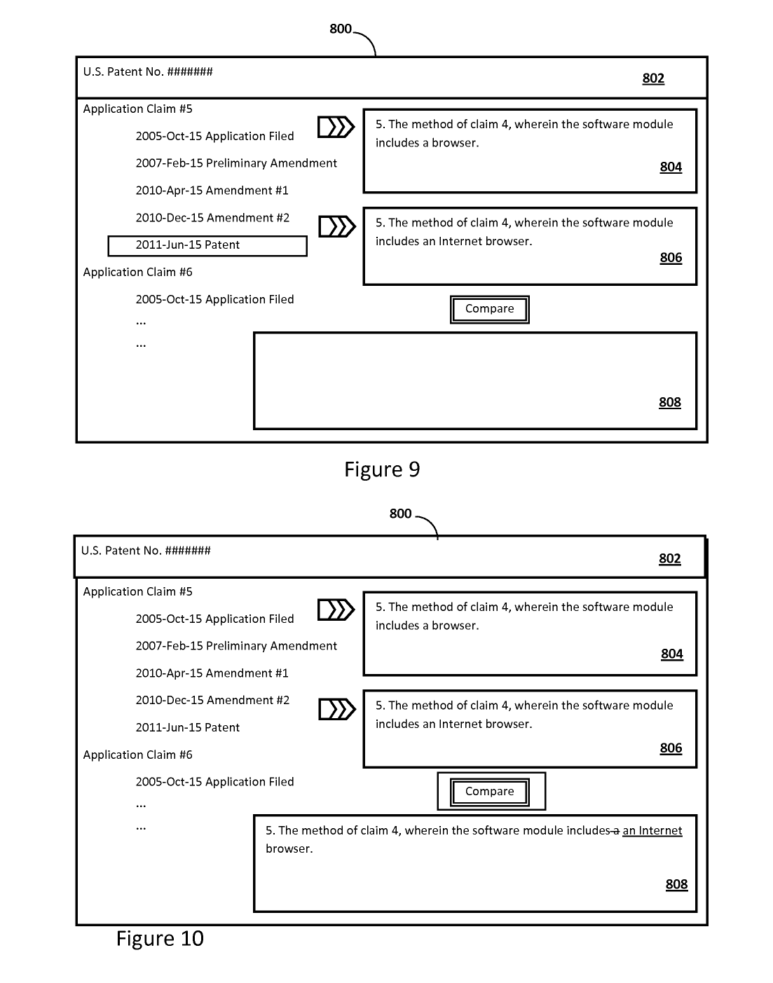

FIG. 9 illustrates the exemplary graphical user interface 800 after the user has selected a second version of claim #5 for display and comparison. The user has selected the last version of claim #5, or patent claim #5, by clicking on “2010 Jun. 15 Patent” on the left side of the interface 800, which highlights the version. After clicking on the arrows box, the text of the last version of the claim is displayed in window 806.

FIG. 10 shows the exemplary graphical user interface 800 after the user has clicked on the Compare button. Upon clicking the Compare button the two selected versions of the claim #5 are compared to each other, and the claim, along with an indication of changes between the two versions, are displayed in window 808. In the preferred embodiment, additions to the claim are underlined and displayed in green color, and deletions from the claim are displayed in red color and with strikethrough, or a line drawn through the text. This highlighting technique emphasizes to the user, what material was added to the claim, and just as importantly, what material was deleted from the claim. This information is extremely hard to gather manually and even harder to keep organized. The present tool not only gathers and organizes, but also allows for viewing from many different perspectives. The present tool will save a lot of valuable time and provide many advantages to patent professionals, and to any professional that deals with composite documents. Or course, other attributes may be used to show added and deleted text from the claims, including using different size and styles of fonts, different colors (other than green and red), highlighting in the different colors (using a simulated highlighting marker), using all CAPS and/or bold, as well as other distinguishing features.

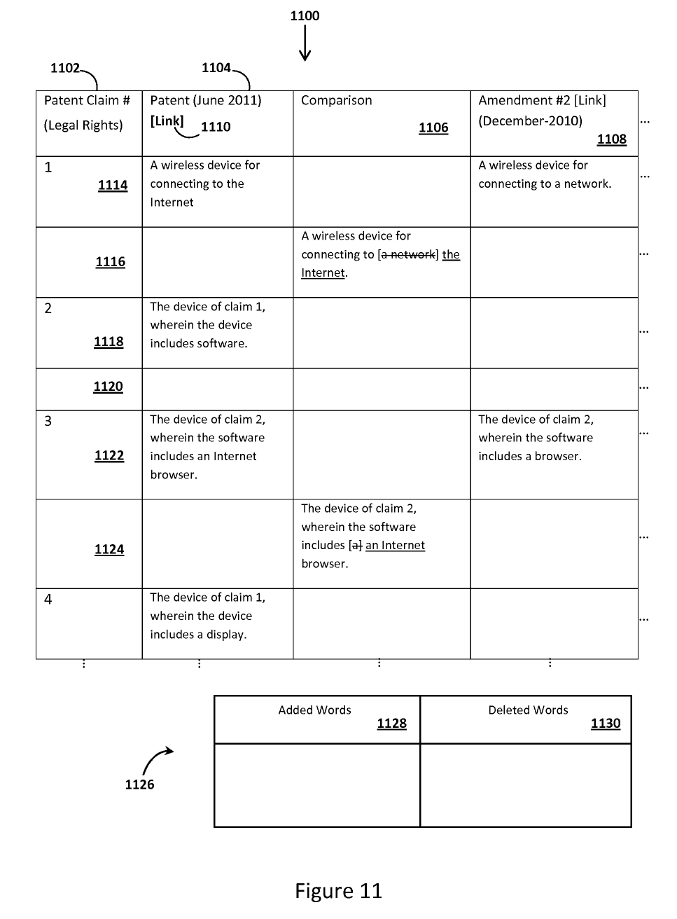

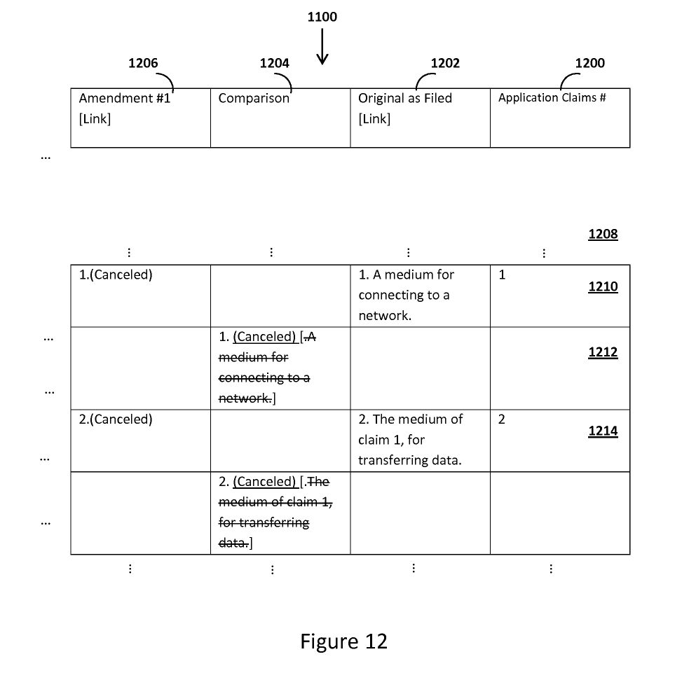

FIG. 11 shows an exemplary comparison matrix 1100 of the claims in a composite document. This comparison view allows for display, and comparison of, multiple claims, and multiple versions of the multiple claims. Since there can be 100, or more, claims, and multiple versions of the claims, to be displayed, some claims matrixes with comparison view can be quite large. FIG. 11 shows the upper, left-hand corner of comparison matrix 1100. The lower, right-hand corner of comparison matrix 1100 is displayed in FIG. 12. Together, these two Figures illustrate the useful layout and advantageous design of this aspect of the invention. The layout of the comparison matrix 1100 includes listing the Patent Claim numbers in the first column 1102, and listing the corresponding Application Claim numbers in the last column of the matrix (shown in FIG. 12). The text of each Patent Claim is provided in the second column 1104. Patent Claim #1, and every version of the claim, are provided in row 1114, of the comparison matrix 1100. In order to unclutter the matrix, and to make changes to the claims to make them easy to find, a separate row and column are provided for the Comparison results. For example, Patent Claim #1 and all version of Patent Claim #1 are found on row 1114. However, the comparisons between adjacent versions of Patent Claim #1 are found in row 1116. The same is true for all displayed claims. Patent Claim #2, shown in row 1118, was not amended in Amendment #2, so there is no comparison view displayed in Comparison column 1106 of row 1120 for Patent Claim #2. However, Patent Claim #3 was changed in Amendment #2. The result of the change to Patent Claim #3 is shown in row 1122. The comparison view, showing what was added and/or deleted from Claim #3 is displayed in row 1124. A row dedicated to showing Comparison views for all claims is provided, and the preferred embodiment allows for displaying more than 4 Patent Claims.

At the top of each column that lists a version of the claim, column 1104 and 1108, for example, is a link, such as Link 1110, that allows the user to display the document associated with that version of the claim, for example, an Amending Document. For example, if the user clicked on Link 1100, a PDF of the Patent associated with the Composite Document would be presented in a separate window. Clicking on the Link in column 1108 would open a PDF of the Component Document, or the Amendment that was filed by the Applicant in December of 2010. Looking at the associated Amending Document gives the patent professional helpful information not shown in the matrix, including reasons why the Applicant made the additions or deletions to the claim(s). Many times, this information is very useful to patent professionals. In the Comparison columns, including 1106, words that are added to the claim are preferably underlined and shown in green color, and words that are deleted are shown in red and with strikethrough. Of course, other highlighting features can be used and selected by the user to distinguish between added and deleted terms.

At the bottom of FIG. 11, is a useful chart 1126 for quickly determining how much the scope of the claims changed during prosecution of the claims through the Patent Office. In column 1128 of the chart 1126, all words that were added to the claims during prosecution are listed, in alphabetical order. In column 1130, all words that were deleted from the claims are listed, also in alphabetical order. While the chart 1126 of added and deleted words has been shown at the bottom of the display, the chart can be placed in multiple positions in the preferred GUI, including along the left or right side of the display screen. In the preferred embodiment, the chart 1126 listing Added & Deleted words is also shown in the GUI of FIGS. 8-10.

FIG. 12 is a continuation of the exemplary comparison matrix 1100 shown in FIG. 11. FIG. 11 shows the upper, left-hand corner of the matrix 1100, and FIG. 12 shows the lower, right-hand corner of the matrix 1100. Another feature of this comparison view is the display of Canceled claims. After all Patent Claims have been displayed, the following row is used to display Canceled claims. Canceled claims numbers are listed in the Application Claim #column 1200, which is the last column in the comparison matrix 1100. The layout of the present matrix allows the user to see the most important claims, the Patent Claims, first. From left to right, the claims then follow a backwards progression toward the version showing the claims as originally filed. In following with this design, Canceled claims are shown on the far right side of the matrix, thus allowing the user easily see where and when the claims were canceled. Since, the matrix shows, from right to left a list of each Amending Document, in chronologic order. At the top of FIG. 12, the right hand side of the top row of comparison matrix 1100 is shown.

The Application Claim numbers are listed in the last column 1200. The text of the claims, as originally filed, are shown in the next column 1202. Column 1204 is a comparison column. Only changes between versions of a claim are shown in column 1204. The changes are purposely placed on a separate row, in order to make reading the matrix as easy as possible for the user, and to make the changes stand out. The text of the claims, as amended by Amendment #1, are shown in column 1206. As in FIG. 11, Links to each component document at the top of pertinent column, such as column 1202 and 1206. In the embodiment, each Link brings up a PDF copy of the component document. However, other types of document and/or images may be used in other embodiments. In FIG. 12, both Application claims 1 and 2 were canceled by Amendment #1. Thus, Comparison column 1204 shows the text of each claim with brackets around them and with strikethrough, indicating the text has been canceled. In the embodiment, deleted text is also displayed using red color or other emphasis. The dashes, or dots, in FIG. 12 indicate that the preferred GUI and show as many columns and rows as are needed to display all claims for any composite document.

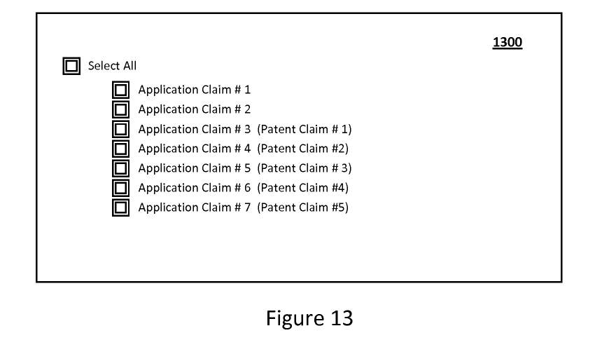

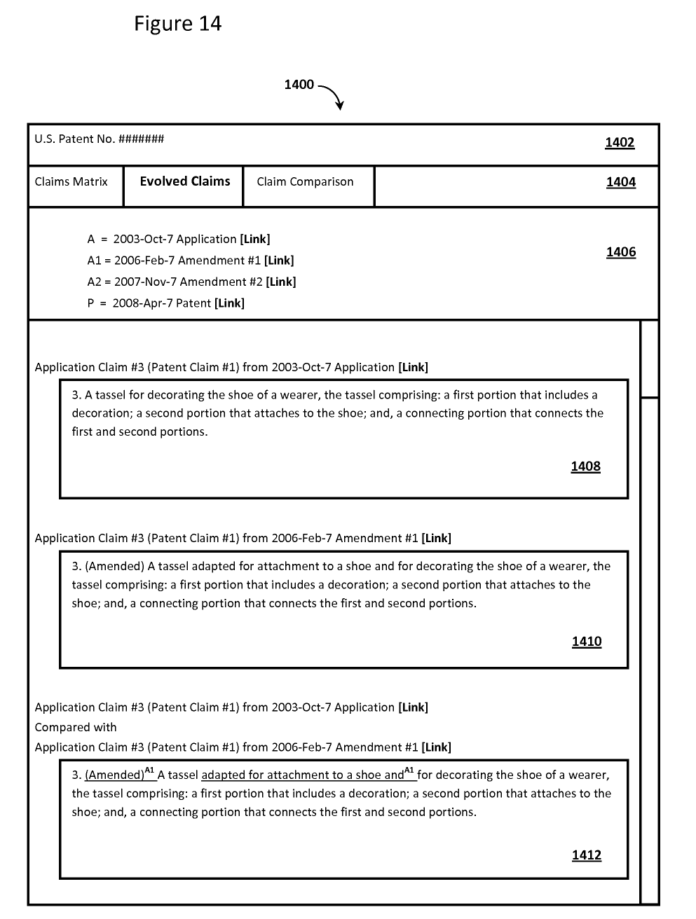

FIG. 13 is an exemplary graphical user interface 1300 for selecting claims to be shown in an evolved claims report, shown in FIGS. 14 & 15. This interface 1300 allows the user to select one or more claims, or select all claims by clicking the Select All button. The interface 1300 also displays the claims as re-numbered by the Patent Examiner prior to issuance as a patent. So, if the user only wants to select claims that issued in the patent, it is easy for the user to select only those claims. In the preferred embodiment, the interface 1300 includes the ability to display and many claims as need be displayed, through the use of a scroll bar, for example.

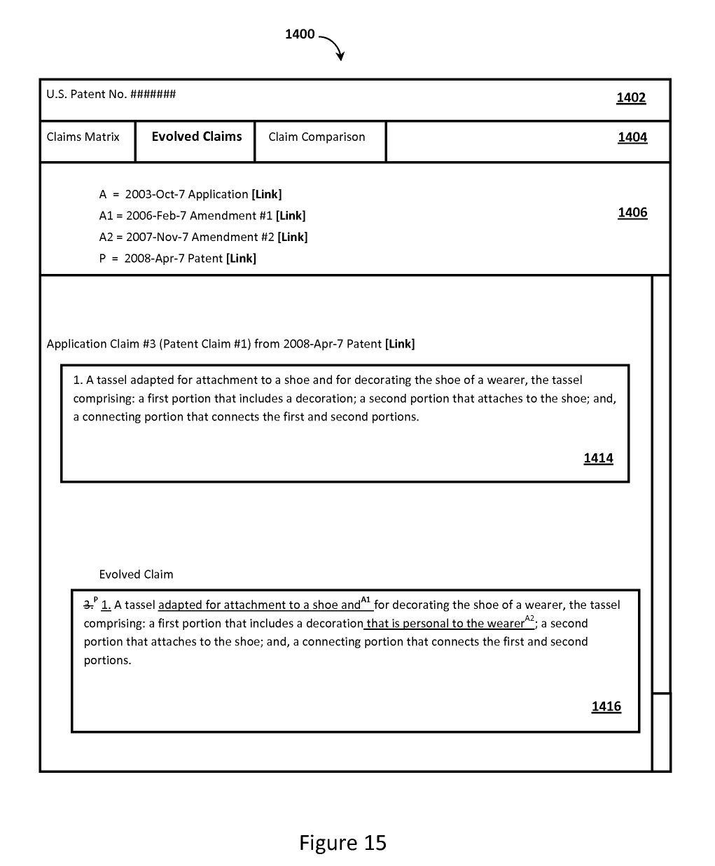

FIG. 14 is an exemplary graphical user interface 1400 that shows the evolution of any claim, from the original filing of the claim to issuance of the claim in a patent. In the preferred embodiment, the evolution of a claim is presented by providing each version of a claim, and comparisons between adjacent component documents. For example, in FIG. 14, the preferred evolution view would include separate windows for the claims as filed, the version of claim in Amendment #1, a comparison view between the claims as filed and the version in Amendment #1, the version in Amendment #2, a comparison view between the versions in Amendment #1 and #2, the patent claims, and a final comparison showing all changes, and annotations indicating which amending document was responsible for the claim. FIGS. 14 and 15, illustrate an embodiment of an evolution view of the present invention. In FIG. 14, the top window 1402 shows the Composite Document ID number. In this example, the Composite Document is the file history of a U.S. Patent, which is identified by the Patent's number. The second window 1404 in the interface 1400 includes selection buttons that allow the user to switch between the Claims Matrix, Evolved Claims, and Claim Comparison views of the preferred GUI. Window 1406 lists all pertinent component documents associated with the Composite Document, and provides a Link, at window 1406, to each corresponding component document. Each component document is assigned an identifier, such as “A1” for Amendment #1. This identifier is used in the comparison window 1412 to identify which Amending Document is responsible for the indicated change. Window 1408 is used to display the first version of the selected claim. The version of the claim is identified directly above the window 1408, and the text of the claim is displayed within window 1408. Window 1410 is used to display the second version of the selected claim. The version of the claim is identified directly above the window 1410, and the text of the claim is displayed within window 1410. Window 1412 shows a comparison view of the two versions of the claim shown in windows 1408 and 1410.

A listing of which two versions of the claim are being compared is shown directly above window 1412. Additions to the claim are underlined and shown in green or with other emphasis. Additionally, an annotation indicating which Amending Document was used to amend the claim is shown with the added or deleted term(s). Preferably, the annotation is the identifier assigned to the Amending Document and shown in window 1406. In the preferred embodiment, the identifier is displayed as a superscript, after the added or deleted term(s). The purpose of the Evolved Claims view is to show how a claim changes from original filing to ultimate issuance as a claim in a patent. In order to avoid confusion, only three windows that display claim versions are shown in FIG. 14. However, in the preferred embodiment, more windows, below window 1412, are provided in order to display other versions of the selected claim, and other comparison views of the claim.

FIG. 15 illustrates the last two windows in the Evolved Claim interface 1400. Window 1414 shows the final version of the claim, or Patent claim 1. The last window in the Evolved Claim view, window 1416 shows all of the changes the claim went through during prosecution through the U.S. Patent Office. The claim had two additions and no deletions. The first addition was added by the Amending Document dated 2006 Feb. 7, called Amendment #1, and having the identifier “A1”. The second addition was added by the Amending Document dated 2007 Nov. 7, called Amendment #2, having identifier “A2”. Thus, window 1416, labeled Evolved Claim, provides the patent professional with the final version of the claim, and all changes made to the claim during prosecution. Additions to the claim are preferably underlined and shown in green or other emphasis. If there were deletions, they would preferably be shown in red strikethrough or other emphasis. Links to the corresponding documents are shown in window 1406. However, the Links can be located at any convenient position of the user interface.

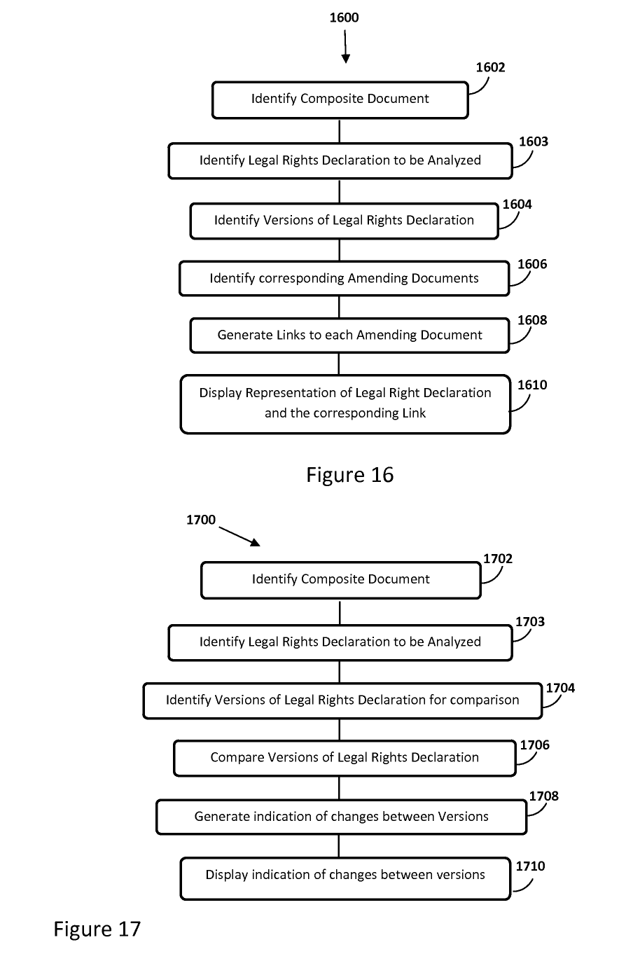

FIG. 16 is a flow chart 1600 illustrating steps of an embodiment. In step 1602, the user enters the identification number of the composite document to be analyzed. In the examples illustrated in the Figures, the composite document ID number is a patent number. The present system takes the patent number and retrieves the file history (composite document) of the patent. The file history includes all papers filed by the Applicant and all papers issued by the Patent Office relating to the patent. Once the patent number is entered, the user is presented with a display similar to FIG. 5, and at step 1603 the user selects at least one claim for analysis. The user is then presented with a display similar to FIG. 6. In step 1604, the user selects, or identifies, the two versions of the claim that he wishes to the display. In step 1606, the present system takes the two versions and identifies the Amending Documents that were filed by the Applicant to create each version. In step 1608, the system generates Links to each of the Amending Documents. Each link allows the user to see a full text version, including images, if included, of the Amending Document. The claim version is only a part of the Amending Document. Patent professionals can gather useful information by looking at and reading the other portions of the document. In step 1610, the versions of the legal rights declaration, or claim, are displayed along with the Link to each Amending Document. The display can be similar to the GUI shown in FIGS. 8-10. If more than one claim is selected, the display can be similar to the chart shown in FIG. 7. In the preferred embodiment, when the user clicks on the link displayed with each version, an Adobe® PDF document opens up in a separate window showing the Amending Document.

FIG. 17 is another flow chart 1700 illustrating steps of an embodiment. In step 1702, the user enters the identification number of the composite document to be analyzed. In this example, a patent number is entered. The present system takes the patent number and retrieves the file history (composite document) of the patent. Once the patent number is entered, the user is presented with a display similar to FIG. 5, and at step 1703 the user selects at least one claim for analysis. The user is then presented with a display similar to FIG. 6. In step 1704, the user selects, or identifies, the two versions of the claim that he wishes to the display. In step 1706, the system compares the two versions of the claim. In step 1708, the system generates indications of the changes between the two versions. In step 1710, the indications of changes between versions are displayed to the user in a way that is easy to see all changes to the claim. The interface and display for this process can be similar to the GUI shown in FIGS. 8-10.

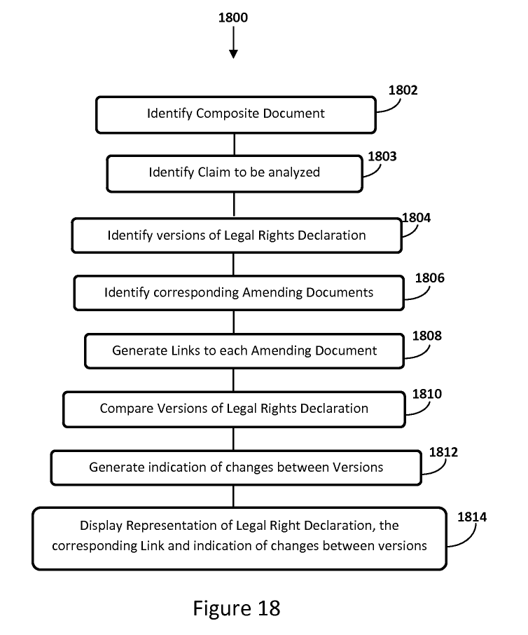

FIG. 18 is another flow chart 1800 illustrating steps of another embodiment. In step 1802, the user enters the identification number of the composite document to be analyzed, a patent number in this example. The system takes the patent number and retrieves the file history (composite document) of the patent. Once the patent number is entered, at step 1803 the user is presented with a display similar to FIG. 5, and the user selects at least one claim for analysis. The user is then presented with a display similar to FIG. 6, and in step 1804, the user selects, or identifies, the two versions of the claim that he wishes to the display. In step 1806, the system takes the two versions and identifies the Amending Documents that were filed by the Applicant to create each version. In step 1808, the system generates links to each of the Amending Documents. Each link allows the user to see a full text version, including images, of the Amending Document. In step 1810, the system compares the two versions of the claim identified in step 1804. In step 1812, the system generates indications of the changes between the two versions. In step 1814, a representation of the Legal Rights Declarations, corresponding links to the associated Amending Documents, and the indications of changes between the versions are displayed to the user in a way that is easy to see all changes that have been made to the claim. The interface and display for this process can be similar to the GUIs shown in FIGS. 13-15.

The foregoing description of the embodiments will so fully reveal the general nature of the invention that others can, by applying current knowledge, readily modify and/or adapt for various applications such specific embodiments without departing from the generic concept. Therefore, such adaptations and modifications should and are intended to be comprehended within the meaning and range of equivalents of the invention. It is to be understood that the phraseology of terminology employed herein is for the purpose of description and not of limitation.

I claim:

1. A method for displaying portions of a composite document representing legal rights, the composite document being composed of plural component documents arranged in an ontology, at least one of the component documents being an amending document that affects changes to a legal rights declaration of the composite document, the method comprising:
receiving a designation of at least two versions of the legal rights declaration;
determining a corresponding amending document for each of the at least two versions of the legal rights declaration;
generating a link to each of the corresponding amending documents; and
displaying a representation of each of the at least two versions of the legal rights declaration along with the link to each of the corresponding amending documents.

2. The method of claim 1, wherein said displaying step comprises displaying each of the at least two versions of the legal rights declaration in a corresponding column or a row of a chart along with the link to each of the corresponding amending documents in the same corresponding column or row of the chart.

3. The method of claim 1, further comprising:
comparing the at least two versions of the legal right declaration;
generating an indication of changes between the at least two versions of the legal right declaration; and
wherein said representation of each of the at least two versions of the legal rights declaration includes the indication of changes between the at least two versions of the legal right declaration and the corresponding amending document is the document that affects the changes indicated by the indication of changes.

4. The method of claim 2, wherein the composite document is a patent file history, the component documents are papers filed by a patent applicant or issued by a patent office, the at least one amending document is a claims amendment, and the legal rights declaration is a patent application claim or a patent claim.

5. The method of claim 3, wherein the composite document is a patent file history, the component documents are papers filed by a patent applicant or issued by a patent office, the at least one amending document is a claims amendment, and the legal rights declaration is a patent application claim or a patent claim.

6. The method of claim 4, wherein said receiving step comprises presenting a user with a claims tree and allowing the user to select the at least two versions of the legal rights declaration from the claims tree.

7. The method of claim 5, wherein said receiving step comprises presenting a user with a claims tree and allowing the user to select the at least two versions of the legal rights declaration from the claims tree.

8. The method of claim 4, wherein said displaying step further comprises displaying an indication of claim dependency.

9. The method of claim 5, wherein said displaying step further comprises displaying an indication of claim dependency.

10. The method of claim 2, wherein the composite document is a single file.

11. The method of claim 3, wherein the composite document is a single file.

12. The method of claim 1, wherein the composite document is a record of a legal transaction.

13. A computer device for displaying portions of a composite document representing legal rights, the composite document being composed of plural component documents arranged in an ontology, at least one of the component documents being an amending document that affects changes to a legal rights declaration of the composite document, the device comprising:
at least one computer processor; and
a memory operatively coupled to the at least one computer processor and having computer executable instructions stored thereon, the instructions, when executed by the at least one processor causing the at least one processor to execute the steps of:
receiving a designation of at least two versions of the legal rights declaration;
determining a corresponding amending document for each of the at least two versions of the legal rights declaration;
generating a link to each of the corresponding amending documents; and
displaying a representation of each of the at least two versions of the legal rights declaration along with the link to each of the corresponding amending documents.

14. The computer device of claim 13, wherein said displaying step comprises displaying each of the at least two versions of the legal rights declaration in a corresponding column or a row of a chart along with the link to each of the corresponding amending documents in the same corresponding column or row of the chart.

15. The computer device of claim 13, the steps further comprising:
comparing the at least two versions of the legal right declaration;
generating an indication of changes between the at least two versions of the legal right declaration; and
wherein said representation of each of the at least two versions of the legal rights declaration includes the indication of changes between the at least two versions of the legal right declaration and the corresponding amending document is the document that affects the changes indicated by the indication of changes.

16. The computer device of claim 14, wherein the composite document is a patent file history, the component documents are papers filed by a patent applicant or issued by a patent office, the at least one amending document is a claims amendment, and the legal rights declaration is a patent application claim or a patent claim.

17. The computer device of claim 15, wherein the composite document is a patent file history, the component documents are papers filed by a patent applicant or issued by a patent office, the at least one amending document is a claims amendment, and the legal rights declaration is a patent application claim or a patent claim.

18. The computer device of claim 16, wherein said receiving step comprises presenting a user with a claims tree and allowing the user to select the at least two versions of the legal rights declaration from the claims tree.

19. The computer device of claim 17, wherein said receiving step comprises presenting a user with a claims tree and allowing the user to select the at least two versions of the legal rights declaration from the claims tree.

20. The computer device of claim 16, wherein said displaying step further comprises displaying an indication of claim dependency.

21. The computer device of claim 17, wherein said displaying step further comprises displaying an indication of claim dependency.

22. The computer device of claim 14, wherein the composite document is a single file.

23. The computer device of claim 15, wherein the composite document is a single file.

24. The computer device of claim 13, wherein the composite document is a record of a legal transaction.

25. Computer readable media having computer readable instructions recorded thereon which, when executed by a computer processor, cause the computer processor to execute a method for displaying portions of a composite document representing legal rights, the composite document being composed of plural component documents arranged in an ontology, at least one of the component documents being an amending document that affects changes to a legal rights declaration of the composite document, the method comprising:
receiving a designation of at least two versions of the legal rights declaration;
determining a corresponding amending document for each of the at least two versions of the legal rights declaration;
generating a link to each of the corresponding amending documents; and
displaying a representation of each of the at least two versions of the legal rights declaration along with the link to each of the corresponding amending documents.

26. The computer readable media of claim 25, wherein said displaying step comprises displaying each of the at least two versions of the legal rights declaration in a corresponding column or a row of a chart along with the link to each of the corresponding amending documents in the same corresponding column or row of the chart.

27. The computer readable media of claim 25, further comprising:
comparing the at least two versions of the legal right declaration;
generating an indication of changes between the at least two versions of the legal right declaration; and
wherein said representation of each of the at least two versions of the legal rights declaration includes the indication of changes between the at least two versions of the legal right declaration and the corresponding amending document is the document that affects the changes indicated by the indication of changes.

28. The computer readable media of claim 26, wherein the composite document is a patent file history, the component documents are papers filed by a patent applicant or issued by a patent office, the at least one amending document is a claims amendment, and the legal rights declaration is a patent application claim or a patent claim.

29. The computer readable media of claim 27, wherein the composite document is a patent file history, the component documents are papers filed by a patent applicant or issued by a patent office, the at least one amending document is a claims amendment, and the legal rights declaration is a patent application claim or a patent claim.

30. The computer readable media of claim 28, wherein said receiving step comprises presenting a user with a claims tree and allowing the user to select the at least two versions of the legal rights declaration from the claims tree.

31. The computer readable media of claim 29, wherein said receiving step comprises presenting a user with a claims tree and allowing the user to select the at least two versions of the legal rights declaration from the claims tree.

32. The computer readable media of claim 28, wherein said displaying step further comprises displaying an indication of claim dependency.

33. The computer readable media of claim 29, wherein said displaying step further comprises displaying an indication of claim dependency.

34. The computer readable media of claim 26, wherein the composite document is a single file.

35. The computer readable media of claim 27, wherein the composite document is a single file.

36. The computer readable media of claim 25, wherein the composite document is a record of a legal transaction.
